(19) United States
(12) Patent Application Publication
(10) Pub. No.: US 2023/0016837 A1
(43) Pub. Date: Jan. 19, 2023

(54) Method for administering a profile for access to a communication network

(71) Applicant: Orange, Issy-Les-Moulineaux (FR)

(72) Inventors: Todor Gamishev, Chatillon Cedex (FR); Laurent Coureau, Chatillon Cedex (FR)

(21) Appl. No.: 17/786,199

(22) PCT Filed: Dec. 17, 2020
(86) PCT No.: PCT/FR2020/052487

§ 371 Date: Jun. 16, 2022

(30) Foreign Application Priority Data
Dec. 20, 2019 (FR) 1915342

(51) Int. Cl. H04L 9/40

(52) U.S. Cl. CPC H04L 63/102; H04L 63/0823; H04L 63/20

(57) ABSTRACT

A method for administering a profile for access to a communication network by using a security module. The security module receives a request to perform an administrative action relating to an access profile originating from an administration entity. The request includes a certificate from the administration entity. The security module verifies that the certificate received is legitimate and that it carries information indicating that the entity is authorised to request the action and, if so, sends an authorisation to perform the action in conjunction with the administration entity. Otherwise, the security module rejects the request.

### CROSS-REFERENCE TO RELATED APPLICATIONS

This application is a Section 371 National Stage Application of International Application No. PCT/FR2020/052487, filed Dec. 17, 2020, which is incorporated by reference in its entirety and published as WO 2021/123629 A1 on Jun. 24, 2021, not in English.

### FIELD OF THE DISCLOSURE

The invention relates to the general field of telecommunications.

The invention more particularly relates to a technique of administration of a profile for access to a communication network by a security module and by an administrative entity.

The administration technique is applicable to the field of mobile communication terminals, and more particularly to eUICCs (eUICC being acronym of embedded Universal Integrated Circuit Card). An embedded eUICC allows a subscription to an operator to be managed remotely, in order to allow a mobile device to access a mobile communication network. This eUICC may be non-removable.

### BACKGROUND OF THE DISCLOSURE

The GSMA (GSMA standing for Global System for Mobile Communications Association) is developing technical specifications for a card of type eUICC that will play the role of a security module, and that is intended to be embedded in a mobile user device. Such a security module may be non-removable and it is thus necessary to perform actions remotely—for example download of a profile to be used to access the network of an operator, or even management of this profile. In the context of M2M services (M2M standing for Machine-to-Machine), the GSMA technical specification “SGP.02-Remote Provisioning Architecture for Embedded UICC Technical Specification” Version 4.0 dated Feb. 25, 2019 specifies an architecture for remotely managing the configuration of an eUICC (or security module). In this architecture, an SM-DP entity (SM-DP standing for Subscription Manager-Data Preparation) is configured to prepare a network access profile for an eUICC security module, and an SM-SR entity (SM-SR standing for Subscription Manager-Secure Routing) controls access to the eUICC module with a view to allowing the access profile to be installed by the SM-DP entity. In addition to this access-control function, the SM-SR entity is responsible for administering the profile after its installation, via actions such as: enabling the profile (“enable”), disabling the profile (“disable”) or even deleting the profile (“delete”). This SM-SR entity is the entry point that the M2M service provider (M2M-SP) employs to access the eUICC module. It will be observed that, in this architecture, the SM-SR entity acts as a checkpoint in the interface between the network operator and the eUICC module and in the interface with the M2M service provider. Thus, it is extremely complex for the M2M service provider to modify its provider as regards the SM-SR entity.

### SUMMARY

One of the aims of the invention is to remedy inadequacies/drawbacks of the prior art and/or to make improvements thereto.

According to a first aspect, one subject of the invention is a method of administration of a profile for access to a communication network by a security module. This method comprises:
receiving a request to execute an administrative action relating to an access profile from an administrative entity, said request comprising a certificate of said entity;
sending an authorization to execute the action in cooperation with the administrative entity when it is verified that the received certificate is legitimate and that it contains information indicating that said entity is authorized to request execution of said action;
sending a rejection of the execute request in the contrary case.

In a corresponding manner, another subject of the invention is a method of administration of a profile for access to a communication network by an administrative entity. This method comprises:
sending to a security module a request to execute an administrative action relating to an access profile, said request comprising a certificate of said entity, said certificate containing information indicating that said entity is authorized to request execution of said action;
receiving an authorization to execute the action in cooperation with the security module, when it is verified by the security module that the certificate is legitimate and that it contains said information.

The invention is intended to address identified drawbacks with implementation of the M2M architecture. Alongside this M2M architecture, the GSMA has provided a different B2C architecture (B2C standing for business-to-consumer) that is not interoperable with the M2M architecture. The proposed technique makes it possible to amalgamate these two architectures. The GSMA technical specification “SGP.22—Remote Sim Provisioning (RSP) Architecture for Consumer Devices” v.2.2.1 dated Dec. 18, 2018 specifies an architecture for remotely managing a security module embedded in a device directly controlled by the end user of the device. Provision is made for a user or customer to be able to subscribe directly via a human-machine interface of his user device, or by going to a shop of the operator or/and for him to install a network access profile. Provision is also made for him to be able to change operator in the same manner. To this end, the GSMA has provided an architecture in which the user device obtains the access profile of an SM-DP+ server responsible for preparing subscription-management data (SM-DP+ standing for Subscription Manager-Data Preparation+), in order to download an access profile that has been prepared for it. The user may then interact with his user device in order to perform operations to administer his access profile. Such an architecture cannot be used to perform access-profile administration operations in M2M use cases.

The proposed technique thus makes it possible, by modifying the B2C architecture provided by the GSMA, to support M2M use cases. By virtue of the proposed technique, the M2M service provider may simply define the entity in charge of an administrative action, such as enabling, disabling and deleting the access profile. The M2M service provider may also subsequently modify this administrative entity. The entity in charge of downloading the access profile is managed by the operator of the communication network with which the access profile is associated. In M2M use cases, it is no longer necessary to download the access profile to communicate with the security module via the SM-SR server.

The proposed technique thus makes it possible to separate roles between distinct administrative entities depending on their interaction either with the operator or with the M2M service provider.

The security module thus verifies whether the administrative entity requesting execution of an administrative action indeed has the rights associated with a role that has been assigned to it. In the M2M architecture, only the SM-SR server has the right to establish a secure link with the security module. The proposed technique authorizes other administrative entities to request execution of an administrative action depending on the role contained in the certificate associated with the entity. The request to execute an administrative action may correspond to a request for authorization to execute the action or indeed may implicitly contain a request for authorization to execute the action.

An access profile corresponds to a set of data and of applications that allow the mobile terminal, once the profile has been enabled, to access the network of an operator.

Two types of administrative entities may be defined:
a first type of administrative entity associated with downloading the access profile to the security module. This first type of entity is typically under the control of the network operator;
a second type of administrative entity associated with managing the access profile once downloaded.

This second type of entity is typically under the control of the M2M service provider.

It is thus possible to define various administrative entities, one role being assigned to each thereof.

The various embodiments or features mentioned below may be added, independently or in combination with one another, to the method of administration of an access profile such as defined above.

In one particular embodiment, the certificate comprises a field indicating an authorization to execute said action.

This allows the security module to verify directly, based on this field, that the administrative entity indeed has the rights required to request an execution of the action. The certificate is signed by the secret key of a master entity and is verified by means of the public key associated with this master entity. The security module is for example initialized in the factory with this public key. This embodiment remains very simple to implement. The master entity is the entity that certifies the roles assigned to the administrative entities.

In one particular embodiment, the certificate is signed by a secret key of a certificate associated with said action indicating an authorization to execute said action.

This allows the security module to verify, based on a public key associated with the role and required to execute the administrative action, that the administrative entity has the required rights. The security module is for example initialized in the factory with one or more public keys, each being associated with one role. The master entity is the entity that certifies the roles assigned to the administrative entities.

In one particular embodiment, said action belongs to the group comprising at least downloading an access profile, enabling an access profile, disabling an access profile, and deleting an access profile. It is thus possible to define various administrative entities, depending on the defined roles.

According to a second aspect, the invention relates to a security module, configured to store in memory a profile for access to a communication network. This module comprises:
a profile-managing module, configured to receive a request to execute an administrative action relating to an access profile from an administrative entity, said request comprising a certificate of said entity, to authorize the execution of the action in cooperation with the administrative entity when it is verified that the certificate received is legitimate and that it contains information indicating that said entity is authorized to request execution of said action, and to reject the request in the contrary case.

The advantages mentioned with regard to the administration method according to the first aspect are directly transposable to a security module.

This security module may of course comprise, in structural terms, the various features relating to the administration method such as described above, which may be combined or implemented separately.

According to a third aspect, the invention relates to an administrative entity for administering a profile for access to a communication network, said entity comprising a control module configured to send, to a security module, a request to execute an administrative action relating to an access profile, said request comprising a certificate of said entity, said certificate containing information indicating that said entity is authorized to request execution of said action, and to receive an authorization to execute the action in cooperation with the security module, when it is verified by the security module that the certificate is legitimate and that it contains said information.

The advantages mentioned with regard to the administration method according to the first aspect are directly transposable to an administrative entity.

This administrative entity may of course comprise, in structural terms, the various features relating to the administration method such as described above, which may be combined or implemented separately.

According to a fourth aspect, the invention relates to an administrative system for administering a profile for access to a communication network, said system comprising an administrative entity according to the third aspect and a master entity that is configured to sign a certificate of the administrative entity, said certificate containing information indicating that said entity is authorized to request execution of said action.

The advantages mentioned with regard to the administration method according to the first aspect are directly transposable to an administrative system.

The administrative system may of course comprise, in structural terms, the various features relating to the administration method such as described above, which may be combined or implemented separately.

According to a fifth aspect, the invention relates to a program for a security module, comprising program-code instructions intended to command the execution of the steps of the method of administration of an access profile described above, said steps being implemented by a security module, when this program is executed by this security module, and to a storage medium readable by a security module, on which a program for a security module is stored.

The advantages mentioned with regard to the method of administration of an access profile according to the first aspect are directly transposable to the program for a security module and to the storage medium.

According to a sixth aspect, the invention relates to a program for an administrative entity, comprising program-code instructions intended to command the execution of the steps of the method of administration of an access profile described above, said steps being implemented by an administrative entity, when this program is executed by this administrative entity, and to a storage medium readable by an administrative entity, on which medium a program for an administrative entity is stored.

The advantages mentioned with regard to the administration method according to the first aspect are directly transposable to the program for an administrative entity and to the storage medium.

### BRIEF DESCRIPTION OF THE DRAWINGS

The technique of administration of an access profile will be better understood by virtue of the following description of particular embodiments, which is given with reference to the appended drawings, in which:

FIG. 1 shows a system in which the method of administration of an access profile is implemented in one particular embodiment;

FIG. 2A illustrates steps of a method of administration of an access profile implemented by a security module according to one particular embodiment;

FIG. 2B illustrates steps of the method of administration of an access profile implemented by an administrative entity according to one particular embodiment;

FIG. 3A shows a certificate tree in a first particular embodiment;

FIG. 3B shows a certificate tree in a second particular embodiment;

FIG. 4A shows a security module in one particular embodiment;

FIG. 4B shows an administrative entity in one particular embodiment.

### DETAILED DESCRIPTION OF ILLUSTRATIVE EMBODIMENTS

In the remainder of the description, examples of a number of embodiments applying to an eUICC security module such as is in the process of being standardized by the GSMA are described, but the method of administration of an access profile also applies to other types of security module. More generally, the security module is an inviolable dedicated platform, comprising hardware and software, able to securely host applications and their confidential and cryptographic data and providing a secure execution environment for applications, and for example a card of type UICC.

The following description is to be read within the context of technical specifications, such as defined by the GSMA. More precisely, the architecture of the remote configuration management is defined in the technical specification “SGP.21 RSP Architecture”, version 2.2, dated Sep. 1, 2017 and the procedures are defined in the GSMA technical specification “SGP.22—Remote Sim Provisioning (RSP) Architecture for consumer Devices” v.2.2.1 dated Dec. 18, 2018.

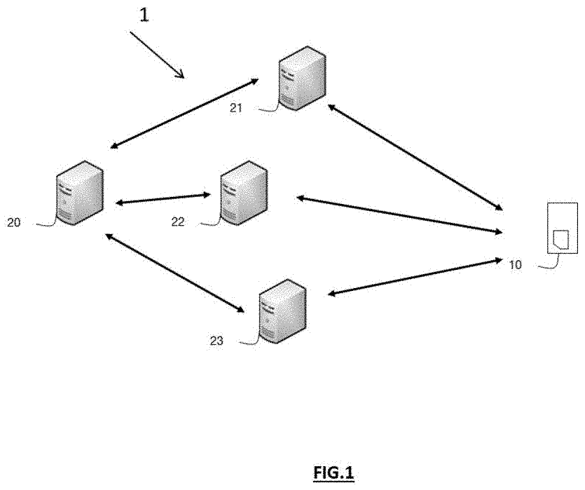

FIG. 1 shows an environment in which is implemented the method of administration of an access profile in one particular embodiment.

A user device (not shown in FIG. 1), with which a security module 10 is associated, is configured to access the network of a mobile operator by means of a network access profile generated by this operator for this security module. An access profile corresponds to a set of data and of applications that allow the mobile terminal, once the profile has been enabled, to access the network of an operator. The user device and the security module together form a mobile terminal. More precisely, the access profile is generated for this security module by a server for managing subscription data (which server is not shown in FIG. 1) that is associated with the operator. The access profile comprises an application for accessing the network and associated access data (also known as credentials), such as algorithms and cryptographic keys. The access profile especially allows the mobile terminal, and more precisely the security module 10, to be authenticated during an access to the network of the operator.

The security module 10 is typically a card of type eUICC (eUICC being the acronym of embedded Universal Integrated Circuit Card), such a card also being called an eSIM (eSIM being the acronym of embedded Subscriber Identity Module) or a non-removable SIM card. No limitations are placed on the type of card. In one particular embodiment, the security module 10 is a chip card with an operating system offering the functionalities of an eUICC. In another particular embodiment the security module 10 is integrated into the terminal, which thus form a single entity. A single security module 10 has been shown in FIG. 1. It will be understood that this is merely an illustrative example.

Four administrative entities have been shown in FIG. 1:
a master entity 20, the main role of which is to distribute roles to the administrative entities 21, 22, 23;
an install entity 21, the main role of which is to download an access profile to a security module;
an enable/disable entity 22, the main role of which is to enable or disable an access profile stored in memory on a security module;
a delete entity 22, the main role of which is to delete an access profile stored in memory on a security module.

These administrative entities are described in the form of functional entities, with one master entity and three administrative entities. A role is assigned by the master entity to each of these three administrative entities. This distribution of roles is non-limiting. A plurality of administrative entities may be grouped together within the same server. One administrative entity may also be assigned a plurality of roles. In FIG. 1, a single administrative entity has been shown per role to be assigned. It will be understood that a plurality of administrative entities may be assigned the same role. In particular, an M2M service provider defines the administrative entities that will manage the security modules used to deliver the M2M service. The number of administrative entities shown in FIG. 1 is non-limiting. It is possible to define as many administrative entities as there are roles to be played with respect to performing an administrative action relating to an access profile.

In the B2C architecture, the SM-DP+ server responsible for preparing the subscription-management data (SM-DP+ standing for Subscription Manager-Data Preparation+) may be chosen to accommodate these various functional administrative entities. The role of this server is to deliver by downloading to a security module an access profile that has been prepared therefor. The role of this server is to:
prepare profile packages,
store profile protection keys in memory in a secure manner and protected profile packages in a memory area, and
allocate profile packages depending on a security-module identifier.

The SM-DP+ server associates a protected profile package with a security module and downloads, once a secure download session has been set up, this or these access profiles via an LPA application (LPA standing for Local Profile Assistant). This LPA application may, depending on the embodiment, be executed in the user device or in the security module 10.

The master entity 20 and the administrative entities 21-23 form an administrative system 1.

Two embodiments of the certificate tree will be described with reference to FIGS. 3A and 3B.

In these two figures, a certificate authority GlobalCA has been shown. This certificate authority has a pair of keys stored in memory: a private key GlobalCA_SK and an associated public key GlobalCA_PK.

Below, in the described embodiments, the public key certificates are in X.509 format. An X.509 certificate is a digital identity card that associates a certified public key with a physical entity. The certificate is issued by a certificate authority following a secure procedure. Once the certificate has been issued, the certified public key may be used by services implementing security functions. A public key certificate consists of a number of fields, especially:
the identity of the certificate authority that issued the certificate,
a certificate-signing algorithm, which is used by the certificate authority to sign the certificate,
a period of validity of the certificate,
the name of the certificate holder,
information on the public key: algorithm to be used with the public key, the public key itself,
the signature of the certificate by the certificate authority,
optional information.

The master entity 20 (denoted SM-DPM in FIGS. 3A and 3B) has a pair of keys stored in memory: a private key CertMaster_SK and an associated public key CertMaster_PK. A public key certificate CertMaster has been issued to certify the public key CertMaster_PK by the certificate authority GlobalCA. The certificate authority signs by means of its private key GlobalCA_SK the certificate CertMaster of the master entity.

The security module 10 has a pair of keys stored in memory: a private key EUICC_SK specific to the security module and an associated public key EUICC_PK. A public key certificate CerteUICC has been issued to certify the public key EUICC_PK by the certificate authority GlobalCA or by the card manufacturer, the latter being called the EUM (for eUICC Manufacturer). In the latter case, the certificate of the EUM is signed by the GSMA certificate authority GlobalCA. This allows the security module 10 to be authenticated by any entity that recognizes the certificate authority GlobalCA.

The install entity 21 (denoted SM-DPI in FIGS. 3A and 3B) has a pair of keys stored in memory: a private key CertDPI_SK and an associated public key CertDPI_PK.

The enable/disable entity 22 (denoted SM-DPED in FIGS. 3A and 3B) has a pair of keys stored in memory: a private key CertDPED_SK and an associated public key CertDPED_PK.

The delete entity 23 (denoted SM-DPD in FIGS. 3A and 3B) has a pair of keys stored in memory: a private key CertDPD_SK and an associated public key CertDPD_PK.

No limitations are placed on the type of certificate. The certificate may in particular be of another type, for example an SSL certificate (SSL standing for secure socket layer). The description is easily transposable to any type of certificate.

A first embodiment will now be described with reference to FIG. 3A. In this embodiment, the certificate of the administrative entities 21, 22, 23 comprises a field indicating an authorization to execute an administrative action on an access profile. More precisely, this field specifies the role that is assigned to the administrative entity with which the certificate is associated. This role corresponds to an authorization to execute an administrative action. In the described case, it is a question of installing an access profile, of enabling or disabling an access profile, and/or of deleting an access profile. This list of administrative actions is non-limiting.

In this first embodiment, the certificates of the administrative entities are signed by the master entity 20. The certificate of the install entity 21 is denoted (CertDPI)_{CertMaster}. The certificate of the enable/disable entity 22 is denoted (CertDPED)_{CertMaster} The certificate of the delete entity 23 is denoted (CertDPD)_{CertMaster}.

In this first embodiment, the security module 10 has two public keys stored in memory: the public key GlobalCA_PK of the certificate authority GlobalCA and the public key CertMaster_PK of the master entity 20. These public keys are for example configured in the factory.

In another embodiment, the certificates of the administrative entities are signed by the certificate authority GlobalCA.

A second embodiment will now be described with reference to the FIG. 3B. In this embodiment, the certificate of the administrative entities 21, 22, 23 is signed by a secret key of a certificate associated with an administrative action relating to an access profile indicating an authorization to execute this action. More precisely, the master entity 20 has three certificates available to it, each of them being associated with one role:
CertInstall is the certificate associated with the role of installing an access profile. The secret key of this certificate CertInstall is used to sign the certificate CertDPI of the install entity 21. The latter certificate is denoted (CertDPI)_{CertInstall};
CertEnD is the certificate associated with the role of enabling/disabling an access profile. The secret key of this certificate CertEnD is used to sign the certificate CertDPED of the enable/disable entity 22. The latter certificate is denoted (CertDPED)_{CertEnD};
CertDel is the certificate associated with the role of deleting an access profile. The secret key of this certificate CertDel is used to sign the certificate CertDPD of the delete entity 23. The latter certificate is denoted (CertDPD)_{CertDel}.

Thus, the role assigned to an administrative entity corresponds to the role associated with the certificate used to sign the certificate of this administrative entity. This role corresponds to an authorization to execute an administrative action. In the described case, it is a question of installing an access profile, of enabling or disabling an access profile, and/or of deleting an access profile.

In this second embodiment, the security module 10 has five public keys stored in memory: the public key GlobalCA_PK of the certificate authority GlobalCA, the public key CertMaster_PK of the master entity 20, the public key CertInstall_PK, the public key CertEnD_PK and the public key CertDel_PK. These public keys are for example configured in the factory.

The master entity 20 thus has the role of assigning rights to each of the administrative entities, i.e. in the described case to the install entity 21, to the enable/disable entity 22, and to the delete entity 23. This assignment of rights is carried out by means of the certificate that is associated with the administrative entity in question.

It may be observed that, in these two embodiments, the security module 10 is able to verify that the certificate provided by an administrative entity indeed contains information indicating that this entity is authorized to request execution of an administrative action relating to an access profile: in the first embodiment, by directly accessing the field containing this information and in the second embodiment, depending on the certificate used to sign the certificate provided by the administrative entity.

Below, a request to execute an administrative action may correspond either to an exchange comprising a request for authorization to execute the action followed by the execution itself, or just to the request to execute, the latter implicitly including a request for authorization to execute the action.

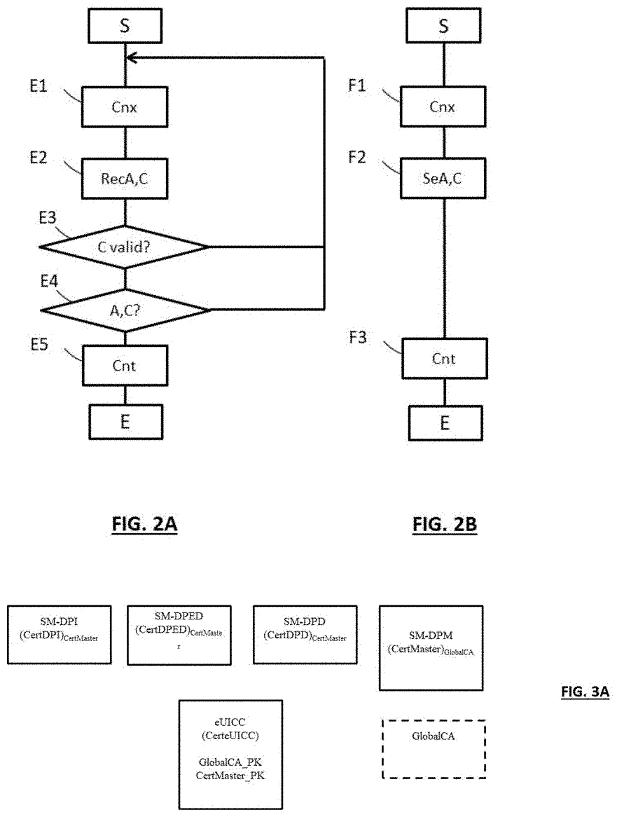

Steps of a method of administration of an access profile implemented by a security module according to one particular embodiment will now be described with reference to FIG. 2A. Steps of the method of administration of an access profile implemented by an administrative entity are, for their part, described with reference to FIG. 2B. Below, by way of illustration, the case where the install entity 21 makes a request to execute an action whereby an access profile is downloaded to the security module 10 will be considered. It will be recalled that, in the described embodiment, the administrative action belongs to the group comprising at least downloading an access profile, enabling an access profile, disabling an access profile, and deleting an access profile. This example is non-limiting, the description being easily transposable to the enable/disable entity 22 enabling/disabling an access profile, to the delete entity 23 deleting an access profile, or indeed even to any administrative action relating to an access profile.

The execution of these steps is in one particular embodiment triggered by a principal (the operator for example) who sends, to the install entity 21, a request to download an access profile to a security module, by providing the information required to identify this security module.

The install entity 21 (step F1) and the security module 10 (step E1) initialize a download procedure after setting up a secure download session as described in the reference specifications SGP.21 and SGP.22. This download session relies on a secure TLS connection (TLS standing for Transport Layer Security) and follows a mutual authentication of the install entity 21 and of the security module 10.

In a step F2, the install entity 21 sends, to the security module 10, a request to execute an administrative action relating to an access profile. More precisely, in the described example, this administrative action corresponds to downloading an access profile. This request comprises a certificate, for example a public key certificate, of this install entity 21. The certificate sent contains information indicating that the install entity is authorized to request execution of the download action. In the first embodiment, this certificate (CertDPI)_{CertMaster} comprises a field indicating an authorization to execute the download action. In the second embodiment, this certificate (CertDPI)_{CertInstall} is signed by a secret key of a certificate CertInstall specific to the downloading role.

The security module 10 receives, in a step E2, the request to execute an administrative action relating to an access profile from the install entity 21, this request comprising a certificate, a public key certificate for example.

In a step E3, the security module 10 verifies that the received certificate is legitimate, and more precisely the security module 10 verifies the validity of the certificate provided by the install entity 21 by means of the corresponding public key CertDPI_PK installed in the security module 10. If this is not the case, the security module 10 does not authorize the execute request, by sending a rejection of the request, and interrupts the download procedure.

If the verification reveals the received certificate to be legitimate, in a step E4, the security module 10 verifies that the received certificate contains information indicating that this entity 21 is authorized to request execution of a download action. In the first embodiment, it is a question of verifying that this certificate (CertDPI)_{CertMaster} comprises a field indicating an authorization to execute the download action. In the second embodiment, it is a question of verifying that this certificate (CertDPI)_{CertInstall} is signed by a secret key of a certificate specific to the downloading role. To perform this verification, the security module 10 has the public key CertInstall_PK of the certificate specific to the downloading role stored in memory. If the security module 10 determines that the received certificate does not contain information indicating that this entity 21 is authorized to request execution of a download action, the security module 10 does not authorize the execute request, by sending a rejection of the request, and interrupts the download procedure.

If the security module 10 verifies that the received certificate contains information indicating that this entity 21 is authorized to request execution of a download action, in a step E5, the security module 10 sends an authorization to execute the download action in cooperation with the install entity 21 (which authorization is received in step F3). The procedure for executing the action, i.e. downloading, continues as described in the technical specifications SGP.21 and SGP.22.

It may be seen that, by virtue of the proposed architecture modification, it is possible to administer security modules both for M2M and B2C services. The security module uses the same technique to interact with the administrative entities. By assigning roles to the administrative entities, the M2M and B2C architectures are amalgamated into a single architecture. In particular, the M2M service provider obtains a freedom to choose a collaborator to whom to outsource the implementation of the actions used to administer an access profile.

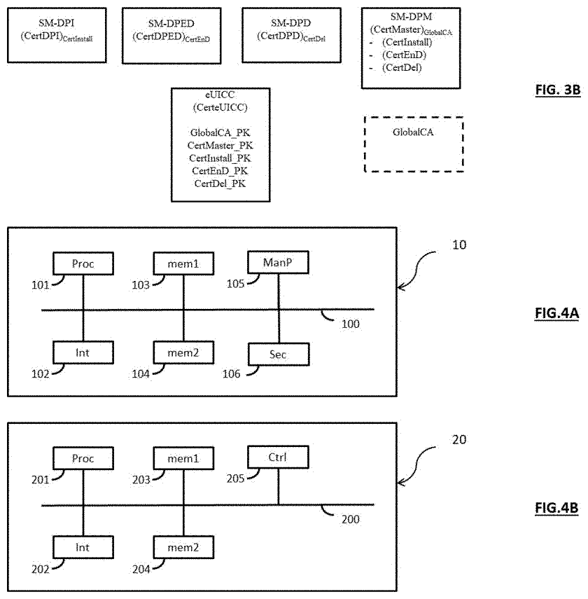

FIG. 4A schematically illustrates a security module 10 in one particular embodiment. The security module 10 especially comprises:
a hardware processor 101 for executing code instructions of software modules;
a memory area 103, configured to store a program that comprises code instructions for implementing steps of the method of administration of an access profile;
a storage memory 104, configured to store data used during the implementation of the method of administration of an access profile, such as parameters used for computations performed by the processor 101, intermediate data of computations performed by the processor 101, etc;
a network interface 102;
a profile-managing sub-module 105, arranged to download and install an access profile and to hold it in a secure container. This module corresponds to an ISD-P module (ISD-P standing for Issuer Security Domain Profile) as defined by the GSMA;
a security-control sub-module 106. This module corresponds to an ECASD module (ECASD for Embedded UICC Controlling Authority Security Domain) as defined by the GSMA;

which are connected to each other through a bus 100.

Of course, the constituent elements of the security module 10 may be connected by means of a connection other than a bus.

It is underlined here that the security module 10 also comprises other processing sub-modules (not shown in FIG. 4A) that are configured to implement various security-module functions.

The processor 101 commands the operations of the security module. The memory area 103 stores at least one computer-program code that, when it is executed by the processor 101, implements the various functions of the security module. The processor 101 may be formed by any known and suitable hardware or software, or by a combination of hardware and software. For example, the processor 101 may be formed by dedicated hardware, such as a processing circuit, or by a programmable processing unit such as a central processing unit which executes a program stored in a memory thereof.

The memory area 103 may be formed by any suitable means capable of storing the program in a computer-readable manner Examples of the memory area 103 comprise computer-readable non-transitory storage media such as: semiconductor memory devices; and magnetic, optical, or magneto-optical storage media loaded into a read-write unit. The program causes the processor 101 to execute a method of administration of an access profile according to one particular embodiment.

A network interface 102 provides a connection between the security module and an administrative entity via a communication network based on an underlying access network.

The security-control sub-module 106 is arranged to securely store authentication data in memory and to provide the following services to the profile-managing sub-module 105: signing data provided to it by means of its secret key CerteUICC_SK, and verifying certificates on request by this sub-module with a public key GlobalCA_PK of the certificate authority or with a public key CertMaster_PK of the master entity.

The following authentication data are in particular stored in memory in the security-control sub-module 106:
the private key CerteUICC_SK of the security module, and the public key certificate CerteUICC of the security module, which comprises the public key CerteUICC_PK; and
the public key GlobalCA_PK of the certificate authority or the public key CertMaster_PK of the master entity.

In the second embodiment the security-control sub-module 106 also contains the public key CertInstall_PK, the public key CertEnD_PK and the public key CertDel_PK.

The security-control sub-module 106 is in particular arranged to verify that a certificate received from an administrative entity requesting execution of an action relating to an access profile is legitimate and that this certificate contains information indicating that this entity is authorized to request execution of this action.

FIG. 4B schematically illustrates an administrative entity 20, 21, 22, 23 in one particular embodiment. The administrative entity 20 especially comprises:
a hardware processor 201 for executing code instructions of software modules;
a memory area 203, configured to store a program that comprises code instructions for implementing steps of the method of administration of an access profile;
a storage memory 204, configured to store data used during the implementation of the method of administration of an access profile, such as parameters used for computations performed by the processor 201, intermediate data of computations performed by the processor 201, etc;
a network interface 202;
a control module 205;
which are connected to each other through a bus 200.

Of course, the constituent elements of the administrative entity may be connected by means of a connection other than a bus.

It is underlined here that the administrative entity also comprises other processing modules (not shown in FIG. 4B) that are configured to implement various administrative-entity functions.

The processor 201 commands the operations of the administrative entity. The memory area 203 stores at least one computer-program code that, when it is executed by the processor 201, implements the various functions of the administrative entity. The processor 201 may be formed by any known and suitable hardware or software, or by a combination of hardware and software. For example, the processor 201 may be formed by dedicated hardware, such as a processing circuit, or by a programmable processing unit such as a central processing unit which executes a program stored in a memory thereof.

The memory area 203 may be formed by any suitable means capable of storing the program in a computer-readable manner Examples of the memory region 203 comprise computer-readable non-transitory storage media such as: semiconductor memory devices; and magnetic, optical, or magneto-optical storage media loaded into a read-write unit. The program causes the processor 201 to execute a method of administration of an access profile according to one particular embodiment.

A network interface 202 provides a connection between the administrative entity and a security module via a communication network based on an underlying access network.

In the master entity 20, the control module 205 is in particular configured to sign a public key certificate of an administrative entity, this certificate containing information indicating that this entity is authorized to request execution of an administrative action relating to an access profile.

The other administrative entities 21, 22, 23 have a structure similar to the one described above with reference to the administrative entity 20. In these entities, the control module 205 is then configured to send, to a security module, a request to execute an administrative action relating to an access profile, this request comprising a certificate of this entity, this certificate containing information indicating that said entity is authorized to request execution of said action, and to receive an authorization to execute the action in cooperation with the security module, when it is verified by the security module that the certificate is legitimate and that it contains this information.

The technique for administering an access profile is implemented by means of software components and/or hardware components. In this regard, the term “module” may correspond in this document equally to a software component, to a hardware component or to a set of hardware and/or software components, able to implement a function or a set of functions, according to what is described above in respect of the module in question.

A software component corresponds to one or more computer programs, one or more subroutines of a program, or more generally to any element of a program or of software. Such a software component is stored in memory and then loaded and executed by a data processor of a physical entity, and is able to access the hardware resources of this physical entity (memories, recording media, communication buses, electronic input/output cards, user interfaces, etc.).

In the same way, a hardware component corresponds to any element of a hardware assembly. It may be a programmable or non-programmable hardware component, with or without an integrated processor for executing software. It is for example an integrated circuit, a chip card, an electronic card for the execution of firmware, etc.

In one particular embodiment, the modules 105 and 106 are configured to implement steps of the method of administration of an access profile, said steps being implemented by a security module. These are preferably software modules comprising software instructions for executing the steps (or actions) of the method of administration of an access profile described above, said steps (or actions) being implemented by a security module. The invention therefore also relates to:
a program for a security module, said program comprising program-code instructions that are intended to command the execution of the steps (or actions) of the method of administration of an access profile described above, when said program is executed by this security module;
a storage medium readable by a security module, on which the program for a security module is stored.

In one particular embodiment, the module 205 is configured to implement steps of the method of administration of an access profile, said steps being implemented by an administrative entity. These are preferably software modules comprising software instructions for executing the steps (or actions) of the administration method described above, said steps (or actions) being implemented by an administrative entity. The invention therefore also relates to:
a program for an administrative entity, said program comprising program-code instructions that are intended to command the execution of the steps (or actions) of the method of administration of an access profile described above, when said program is executed by this administrative entity;
a storage medium readable by an administrative entity, on which medium the program for such an entity is stored.

The software modules may be stored in or transmitted by a data medium. This may be a hardware storage medium, for example a CD-ROM, a floppy disk or a hard disk, or else a transmission medium such as an electrical, optical or radio signal, or a telecommunication network.

The invention therefore also relates to a security module configured to store in memory a profile for access to a communication network, said module comprising a processor configured to:
receive a request to execute an administrative action relating to an access profile from an administrative entity, said request comprising a certificate of said entity;
send an authorization to execute the action in cooperation with the administrative entity when it is verified that the received certificate is legitimate and that it contains information indicating that said entity is authorized to request the execution of said action;
send a rejection of the execute request in the contrary case.

The invention therefore also relates to an administrative entity, configured to administer a profile for access to a communication network, said method comprising:
sending to a security module a request to execute an administrative action relating to an access profile, said request comprising a certificate of said entity, said certificate containing information indicating that said entity is authorized to request execution of said action;
receiving an authorization to execute the action in cooperation with the security module, when it is verified by the security module that the certificate is legitimate and that it contains said information.

Although the present disclosure has been described with reference to one or more examples, workers skilled in the art will recognize that changes may be made in form and detail without departing from the scope of the disclosure and/or the appended claims.

1. A method of administration of a profile for access to a communication network by a security module, said method comprising:
receiving a request to execute an administrative action relating to an access profile from an administrative entity, said request comprising a certificate of said entity;
sending an authorization to execute the action in cooperation with the administrative entity when it is verified that the received certificate is legitimate and that the received certificate contains information indicating that said entity is authorized to request execution of said action; and
sending a rejection of the execute request in the contrary case.

2. A method of administration of a profile for access to a communication network by an administrative entity, said method comprising:
sending to a security module a request to execute an administrative action relating to an access profile, said request comprising a certificate of said entity, said certificate containing information indicating that said entity is authorized to request execution of said action; and
receiving an authorization to execute the action in cooperation with the security module, when it is verified by the security module that the certificate is legitimate and that the certificate contains said information.

3. The method as claimed in claim 1, wherein the certificate comprises a field indicating an authorization to execute said action.

4. The method as claimed in claim 1, wherein the certificate is signed by a secret key of a certificate associated with said action indicating an authorization to execute said action.

5. The method as claimed in claim 1, wherein said action belongs to the group consisting of downloading an access profile, enabling an access profile, disabling an access profile, and deleting an access profile.

6. A security module, configured to store in memory a profile for access to a communication network, said module comprising:
a processor; and
a non-transitory computer-readable medium comprising instructions stored thereon which when executed by the processor configure the security module to:
to receive a request to execute an administrative action relating to an access profile from an administrative entity, said request comprising a certificate of said entity; and
authorize execution of the action in cooperation with the administrative entity when it is verified that the certificate received is legitimate and that the certificate contains information indicating that said entity is authorized to request execution of said action, and to reject the request in the contrary case.

7. An administrative entity for administering a profile for access to a communication network, said entity comprising:
a processor; and
a non-transitory computer-readable medium comprising instructions stored thereon which when executed by the processor configure the administrative entity to:
send, to a security module, a request to execute an administrative action relating to an access profile, said request comprising a certificate of said entity, said certificate containing information indicating that said entity is authorized to request execution of said action, and
receive an authorization to execute the action in cooperation with the security module, when it is verified by the security module that the certificate is legitimate and that the certificate contains said information.

8. An administrative system for administering the profile for access to the communication network, said system comprising the administrative entity as claimed in claim 7 and a master entity that is configured to sign the certificate of the administrative entity, said certificate containing the information indicating that said entity is authorized to request execution of said action.

9. (canceled)

10. A non-transitory computer-readable storage medium comprising program-code instructions stored thereon to command execution of a method of administration of a profile for access to a communication network, when the instructions are executed by a processor of a security module, said method comprising:
receiving a request to execute an administrative action relating to an access profile from an administrative entity, said request comprising a certificate of said entity;
sending an authorization to execute the action in cooperation with the administrative entity when it is verified that the received certificate is legitimate and that the received certificate contains information indicating that said entity is authorized to request execution of said action; and
sending a rejection of the execute request in the contrary case.

11. (canceled)

12. A non-transitory computer-readable storage medium comprising program-code instructions stored thereon to command execution of a method of administration of a profile for access to a communication network by an administrative entity, when the instructions are executed by a processor of the administration entity, said method comprising:
sending to a security module a request to execute an administrative action relating to an access profile, said request comprising a certificate of said entity, said certificate containing information indicating that said entity is authorized to request execution of said action; and
receiving an authorization to execute the action in cooperation with the security module, when it is verified by the security module that the certificate is legitimate and that the certificate contains said information.

13. The method as claimed in claim 2, wherein the certificate comprises a field indicating an authorization to execute said action.

14. The method as claimed in claim 2, wherein the certificate is signed by a secret key of a certificate associated with said action indicating an authorization to execute said action.

15. The method as claimed in claim 2, wherein said action belongs to the group consisting of downloading an access profile, enabling an access profile, disabling an access profile, and deleting an access profile.
